(19) United States
(12) Patent Application Publication
(10) Pub. No.: US 2026/0100458 A1
(43) Pub. Date: Apr. 9, 2026

(54) CAP ASSEMBLY, SECONDARY BATTERY INCLUDING SAME, AND METHOD FOR MANUFACTURING SECONDARY BATTERY

(71) Applicant: SAMSUNG SDI CO., LTD., Yongin-si (KR)

(72) Inventor: Heonwoong LEE, Yongin-si (KR)

(21) Appl. No.: 19/063,583

(22) Filed: Feb. 26, 2025

(30) Foreign Application Priority Data
Oct. 4, 2024 (KR) 10-2024-0134925

(51) Int. Cl. H01M 50/153; H01M 50/171; H01M 50/181; H01M 50/184; H01M 50/188; H01M 50/193; H01M 50/30; H01M 50/528; H01M 50/536

(52) U.S. Cl. CPC H01M 50/153; H01M 50/171; H01M 50/181; H01M 50/184; H01M 50/188; H01M 50/193; H01M 50/394; H01M 50/528; H01M 50/536

(57) ABSTRACT

A cap assembly includes a cap plate having a through-hole, the cap plate being couplable to an opening of a case accommodating an electrode assembly of a secondary battery, a terminal plate inserted into the through-hole of the cap plate, the terminal plate being electrically connectable to the electrode assembly; and a first sealing member between the cap plate and the terminal plate, the first sealing member being positioned adjacent to the through-hole of the cap plate, and the first sealing member including at least one opening in fluid communication with the through-hole of the cap plate and defining a flow path.

### CROSS-REFERENCE TO RELATED APPLICATION

This application claims priority under 35 U.S.C. § 119 to Korean Patent Application No. 10-2024-0134925, filed in the Korean Intellectual Property Office on Oct. 4, 2024, the entire contents of which are hereby incorporated by reference.

### BACKGROUND

### 1. Field

Aspects of embodiments of the present disclosure relate to a cap assembly, a secondary battery including the cap assembly, and a method for manufacturing the secondary battery.

### 2. Description of the Related Art

Unlike primary batteries that are not designed to be (re)charged, secondary (or rechargeable) batteries are batteries that are designed to be discharged and recharged.

Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

A coin-type secondary battery or a button-type secondary battery may be manufactured by inserting an electrode assembly into a case and subsequently sealing the case with a cap assembly. For instance, an electrode tab connected to the electrode assembly may be coupled to an inner surface of the case and/or the cap assembly, followed by sealing the case by welding the case and the cap assembly along an outer circumferential surface of the cap assembly.

The above information disclosed in this Background section is for enhancement of understanding of the background of the present disclosure, and therefore, it may contain information that does not constitute related (or prior) art.

### SUMMARY

A cap assembly according to an embodiment of the present disclosure includes a cap plate having a through-hole and coupled to an opening of a case accommodating an electrode assembly of a secondary battery, a terminal plate electrically connected to the electrode assembly and inserted into the through-hole of the cap plate, and a first sealing member disposed between the cap plate and the terminal plate to be positioned adjacent to the through-hole of the cap plate. Further, the first sealing member includes at least one opening forming a flow path connected to the through-hole.

According to an embodiment of the present disclosure, the first sealing member may include an insulating material.

According to an embodiment of the present disclosure, the cap assembly described above may further include a second sealing member disposed to seal each of the at least one opening of the first sealing member during a formation process of the secondary battery. Further, the second sealing member may be removed from each of the at least one opening of the first sealing member after the formation process.

According to an embodiment of the present disclosure, the second sealing member may be an adhesive tape including a polyimide material.

According to an embodiment of the present disclosure, the flow path formed by the at least one opening of the first sealing member may correspond to a flow path through which gas generated inside the case is discharged to the outside of the case.

According to an embodiment of the present disclosure, the cap assembly described above may further include a third sealing member disposed to seal each of the at least one opening of the first sealing member after the gas is discharged through each of the at least one opening of the first sealing member.

According to an embodiment of the present disclosure, the third sealing member may include an insulating material having adhesive properties.

According to an embodiment of the present disclosure, the insulating material may include at least one of a polypropylene adhesive, a silicone adhesive, an epoxy adhesive, or a urethane adhesive.

According to an embodiment of the present disclosure, the at least one opening of the first sealing member may include a first opening and a second opening, and the third sealing members may include a first closure disposed to seal the first opening and a second closure disposed to seal the second opening.

According to an embodiment of the present disclosure, the first opening and the second opening may be arranged to be opposite to each other about a center axis of the through-hole.

According to an embodiment of the present disclosure, an angle formed by a first side of the opening of the first sealing member, a second side opposite to the first side, and a center of the terminal plate may be in a range from 10 degrees to 15 degrees.

According to an embodiment of the present disclosure, the terminal plate may include a flange portion disposed on the cap plate to cover the through-hole, and a protrusion extending downward from a central region of the flange portion and passing through the through-hole.

A secondary battery according to an embodiment of the present disclosure includes an electrode assembly including a first electrode, a separator, and a second electrode, a case electrically connected to the first electrode and accommodating the electrode assembly through an opening formed at one side thereof, and a cap assembly electrically connected to the second electrode and coupled to the opening of the case to seal the electrode assembly from the outside. The cap assembly includes a cap plate coupled to the opening of the case and having a through-hole, a terminal plate electrically connected to the second electrode and inserted into the through-hole of the cap plate, and a first sealing member disposed between the cap plate and the terminal plate to be positioned adjacent to the through-hole of the cap plate. Further, the first sealing member may include an opening forming a flow path connected to the through-hole.

According to an embodiment of the present disclosure, the cap assembly may further include a second sealing member disposed to seal the opening of the first sealing member during a formation process of the secondary battery. Further, the second sealing member may be removed from the opening of the first sealing member after the formation process.

According to an embodiment of the present disclosure, the flow path formed by the opening of the first sealing member may correspond to a flow path through which gas generated inside the case is discharged to the outside of the case.

According to an embodiment of the present disclosure, the cap assembly may further include a third sealing member disposed to seal the opening of the first sealing member after the gas is discharged through the opening of the first sealing member.

A method for manufacturing a secondary battery according to an embodiment of the present disclosure includes preparing an electrode assembly including a first electrode, a separator, and a second electrode, accommodating the electrode assembly in a case having an opening formed at a first side of the case, manufacturing a cap assembly including a terminal plate inserted into a through-hole formed through a cap plate, electrically connecting the terminal plate to the electrode assembly, and coupling the cap assembly to the first side of the case to seal the opening of the case. The cap assembly includes a first sealing member disposed between the cap plate and the terminal plate to be positioned adjacent to the through-hole of the cap plate, and the first sealing member includes an opening forming a flow path connected to the through-hole of the cap plate.

According to an embodiment of the present disclosure, the manufacturing of the cap assembly may include preparing the terminal plate and the cap plate having the through-hole, disposing the first sealing member between the terminal plate and the cap plate to be positioned adjacent to the through-hole of the cap plate, and thermally bonding the first sealing member to the cap plate and the terminal plate.

According to an embodiment of the present disclosure, the manufacturing of the cap assembly may further include sealing the opening of the first sealing member with a second sealing member. Further, the method may further include performing a formation process of the secondary battery, removing the second sealing member from the opening of the first sealing member, and discharging gas generated inside the case through the opening of the first sealing member by applying vacuum and pressure to the case.

According to an embodiment of the present disclosure, the method described above may further include sealing the opening of the first sealing member with a third sealing member after discharging the gas generated inside the case through the opening of the first sealing member.

### BRIEF DESCRIPTION OF DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings.

FIG. 1 illustrates a cross-sectional view of an example of a secondary battery according to an embodiment of the present disclosure.

FIG. 2 illustrates an example of a cap assembly according to an embodiment of the present disclosure.

FIG. 3 illustrates a perspective view of an example of a first sealing member according to an embodiment of the present disclosure.

FIG. 4 illustrates a manufacturing process of a cap assembly according to an embodiment of the present disclosure.

FIG. 5 illustrates an example of a second sealing member according to an embodiment of the present disclosure.

FIG. 6 illustrates an example of a degassing process according to an embodiment of the present disclosure.

FIG. 7 illustrates an example of a third sealing member according to an embodiment of the present disclosure.

FIG. 8 illustrates a plan view and a cross-sectional view of an example of a cap assembly according to an embodiment of the present disclosure.

FIG. 9 illustrates a plan view and a cross-sectional view of an example of a cap assembly according to an embodiment of the present disclosure.

FIG. 10 illustrates a plan view and a cross-sectional view of an example of a cap assembly according to an embodiment of the present disclosure.

FIG. 11 illustrates a flowchart of a method for manufacturing a secondary battery according to an embodiment of the present disclosure.

### DETAILED DESCRIPTION

Hereinafter, embodiments of the present disclosure will be described, in detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term to explain his/her invention in the best way.

The embodiments described in this specification and the configurations shown in the drawings are only some of the embodiments of the present disclosure and do not represent all of the technical ideas, aspects, and features of the present disclosure.

Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

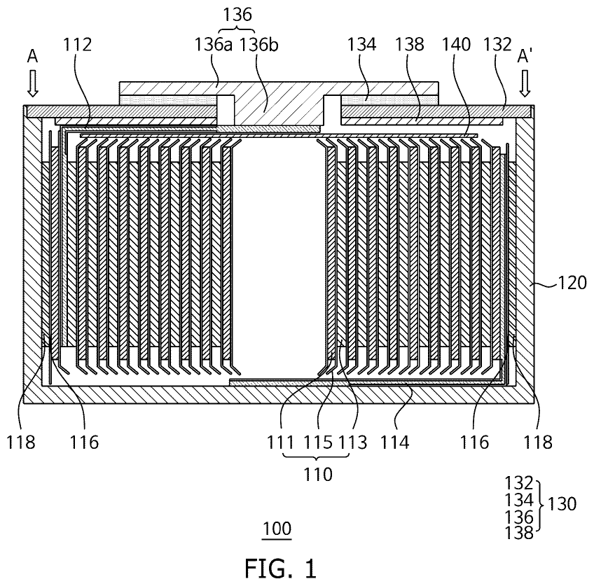

In the present disclosure, sizes (dimensions) and relative sizes (dimensions) of layers and regions shown in FIGS. 1 to 11 may be exaggerated for clarity of illustration. That is, the sizes (dimensions) shown in FIGS. 1 to 11 are for the sake of convenience of understanding and are not intended to limit the scope of the present disclosure. Furthermore, throughout the specification, like reference numerals will be given to like parts.

FIG. 1 illustrates a cross-sectional view of an example of a secondary battery 100 according to an embodiment of the present disclosure. FIG. 1 illustrates a cross-sectional view showing a structure in which the secondary battery 100 is cut in a height direction along a line passing through the center of the secondary battery 100. The secondary battery 100 may include an electrode assembly 110, a case 120, and a cap assembly 130.

The secondary battery 100 may be a coin-type secondary battery (e.g., a coin cell) or a button-type secondary battery (e.g., a button cell). For example, the secondary battery 100 may have a columnar shape. In another example, the secondary battery 100 may have a cylindrical shape, a prismatic shape, a pouch shape, or the like.

The electrode assembly 110 may include a first electrode 111, a second electrode 113, and a separator 115. Specifically, the electrode assembly 110 may be configured by winding the first electrode and the second electrode together with the separator disposed between the first electrode and the second electrode. The electrode assembly 110 may be wound to have a winding core and may further include a through-hole formed at the winding core.

The first electrode may include a first substrate and a first active material layer applied onto the first substrate. A first electrode tab 112 may extend outward from a first uncoated portion of the first substrate where the first active material layer is not applied, and the first electrode tab 112 may be electrically connected to a terminal plate 136 of the cap assembly 130.

The second electrode may include a second substrate and a second active material layer applied onto the second substrate. A second electrode tab 114 may extend outward from a second uncoated portion of the second substrate where the second active material layer is not applied, and the second electrode tab 114 may be electrically connected to the case 120. The first electrode tab 112 and the second electrode tab 114 may extend in opposite directions from each other.

In an embodiment, each of the first electrode tab 112 and the second electrode tab 114 may be covered with a cover tape. The cover tape may include an insulating material. The insulating material may provide electrical insulation to prevent current from passing therethrough. The cover tape may prevent a short circuit from occurring between the first electrode tab 112 and the second electrode tab 114.

The first electrode may serve as a positive electrode. In this case, the first substrate may be formed of, for example, aluminum foil, and the first active material layer may include, for example, a transition metal oxide. The second electrode may serve as a negative electrode. In this case, the second substrate may be formed of, for example, copper foil or nickel foil, and the second active material layer may include, for example, graphite.

The separator may function to prevent a short circuit between the first electrode and the second electrode while allowing movement of lithium ions. The separator may be formed of, for example, a polyethylene film, a polypropylene film, a polyethylene-polypropylene film, or the like.

For example, referring to FIG. 1, the first electrode tab 112 of the first electrode may be formed on one side of the electrode assembly 110, and the second electrode tab 114 of the second electrode may be formed on the other side of the electrode assembly 110. In another example, the first electrode tab 112 and the second electrode tab 114 may be formed on one side of the electrode assembly 110.

The case 120 may accommodate the electrode assembly 110 and an electrolyte. The case 120, together with the cap assembly 130, may form the external appearance of the secondary battery 100. The case 120 may include a substantially cylindrical body portion and a bottom portion connected to one side (e.g., to one end) of the body portion. However, the case 120 may be configured in various shapes such as a prismatic shape, a pouch shape, or the like. In some embodiments, the case may be made of a metal such as aluminum, an aluminum alloy, or nickel-plated steel, a laminated film, or plastic (e.g., in a pouch-type embodiment).

The case 120 may accommodate the electrode assembly 110. The electrode assembly 110 may be inserted into the case 120 through an opening formed at one side of the case 120. Thereafter, the opening of the case 120 may be sealed by the cap assembly 130. The cap assembly 130 may be coupled to one side of the case 120.

The cap assembly 130 may include a cap plate 132, a first sealing member 134, the terminal plate 136, and an insulating member 138. Here, the cap plate 132 may cover the opening of the case 120. The cap plate 132 may be coupled (e.g., couplable) to a side surface of the case 120, which corresponds to a side surface of the opening.

A through-hole may be formed through the cap plate 132. For example, the through-hole may be formed at the center of the cap plate 132. The terminal plate 136 may be inserted into the through-hole and coupled to the cap plate 132. The terminal plate 136 may include a flange portion 136a and a protrusion 136b extending downward from, e.g., a central, region of the flange portion 136a and passing through the through-hole. Here, the protrusion 136b of the terminal plate 136 may be inserted into the through-hole of the cap plate 132. Additionally, the protrusion 136b of the terminal plate 136 may be connected (e.g., connectable) to the first electrode tab 112 by contacting the first electrode tab 112. Referring to FIG. 1, the cap assembly 130 including the terminal plate 136 may be coupled to the case 120 such that the protrusion 136b faces the electrode assembly 110.

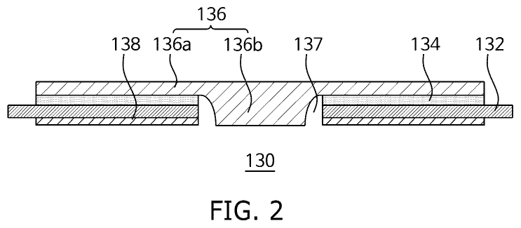

The first sealing member 134 may be disposed between the terminal plate 136 and the cap plate 132. The first sealing member 134 may have adhesive properties so as to couple the terminal plate 136 and the cap plate 132. The first sealing member 134 may be formed of an insulating material so as to electrically insulate the terminal plate 136 from the cap plate 132. The first sealing member 134 may include an opening that forms a flow path (e.g., gas flow path) connected to the through-hole of the cap plate 132. During a formation process of the secondary battery 100, the opening of the first sealing member 134 may be sealed by an additional sealing member (e.g., a second sealing member). The second sealing member may be removed from the opening of the first sealing member 134 after the formation process, allowing an internal gas generated during the formation process to be vented through the opening. After the internal gas is vented through the opening, the opening of the first sealing member 134 may be resealed by an additional sealing member (e.g., a third sealing member). This will be described in more detail with reference to FIGS. 2 to 11.

In an embodiment, the insulating member 138 may be disposed on a lower surface of the cap plate 132. Here, an upper surface of the cap plate 132 may face the flange portion 136a of the terminal plate 136, and the lower surface of the cap plate 132 may face the electrode assembly. The insulating member 138 may be formed of an insulating material to provide electrical insulation between the cap plate 132 and the electrode assembly 110 or between the cap plate 132 and the first electrode tab 112.

In an embodiment, the electrode assembly 110 may include a negative electrode substrate 116 surrounding an outer circumferential surface thereof. In this case, the negative electrode substrate 116 may be formed of the same material as the substrate of the second electrode. In some embodiment, the substrate of the second electrode in the electrode assembly 110 may extend and be wound to surround an outer circumferential surface of the electrode assembly. In this case, the substrate of the second electrode may serve as the negative electrode substrate.

In an embodiment, the electrode assembly 110 may include a sealing tape 118 that surrounds at least a portion of the outermost circumferential surface of the electrode assembly 110 (i.e., at least a portion of the outer circumferential surface of the negative electrode substrate 116). The sealing tape 118 may serve to seal the wound electrode assembly 110. For example, the winding of the first electrode, the second electrode, and the separator in the electrode assembly 110 may be maintained by the sealing tape 118 without unwinding. For instance, the sealing tape 118 may have adhesive properties so as to be bonded with at least a portion of the outermost circumferential surface of the electrode assembly 110. The sealing tape 118 may include an insulating material. For example, the sealing tape 118 may include at least one of polyimide (PI), polyethylene (PE), or polystyrene (PS).

In an embodiment, the first electrode tab 112 may be bent under the terminal plate 136 within the case 120 where the electrode assembly 110 is accommodated and the cap assembly 130 is coupled. The bent first electrode tab 112 may be prevented from short-circuiting with the electrode assembly 110 by an insulating washer 140. The insulating washer 140 may be disposed between the electrode assembly 110 and the terminal plate 136. For example, the insulating washer 140 may be disposed between the electrode assembly 110 and the first electrode tab 112 that is located below the terminal plate 136. The insulating washer 140 may include an insulating material. The insulating washer 140 may separate the first electrode tab 112 from the electrode assembly 110. Further, the insulating washer 140 may provide electrical insulation between the first electrode tab 112 and the electrode assembly 110.

The area where the case 120 and the cap assembly 130 come into contact may be welded to allow the case 120 and the cap assembly 130 to be coupled. Referring to FIG. 1, the case 120 and the cap assembly 130 may be coupled by performing welding at welding areas A and A′.

FIG. 2 illustrates an example of the cap assembly 130 according to an embodiment of the present disclosure. The cap assembly 130 shown in FIG. 2 may correspond to the cap assembly 130 of the secondary battery shown in FIG. 1. The cap assembly 130 may include the cap plate 132, the terminal plate 136, the first sealing member 134, and the insulating member 138.

Referring to FIG. 2, the cap plate 132 may be coupled to an opening of a case that accommodates an electrode assembly. A through-hole 137 may be formed through the cap plate 132. The terminal plate 136 may be electrically connected to the electrode assembly. The terminal plate 136 may be inserted into the through-hole 137 of the cap plate 132.

The terminal plate 136 may include the flange portion 136a that covers the through-hole 137 and is positioned on the cap plate 132, and the protrusion 136b that extends downward from the central region of the flange portion 136a and passes through the through-hole 137. For example, the terminal plate 136 may include the protrusion 136b and the flange portion 136a, which extends along an outer surface of the cap plate 132 from the protrusion 136b.

The through-hole 137 may be formed at the center of the cap plate 132. The protrusion 136b of the terminal plate 136 may be inserted into the through-hole 137 of the cap plate 132, such that the terminal plate 136 is coupled to the cap plate 132.

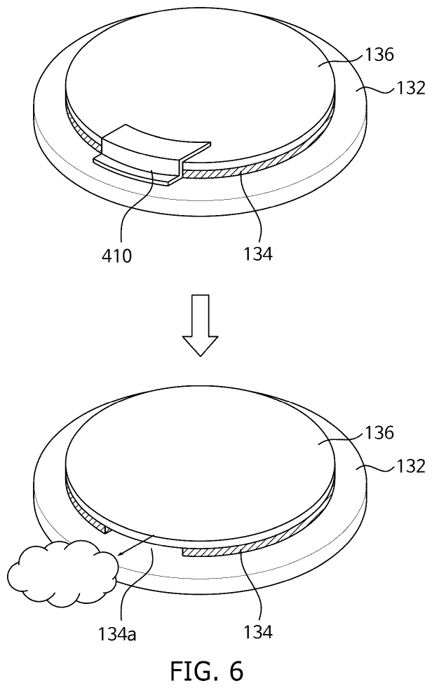

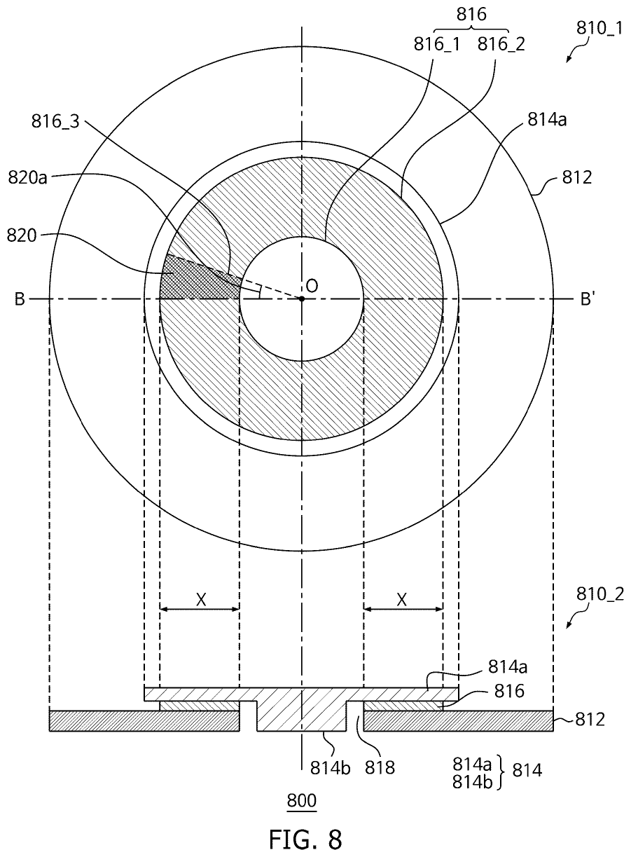

The first sealing member 134 may be disposed between the cap plate 132 and the terminal plate 136. For example, the first sealing member 134 may be positioned adjacent to the through-hole 137 of the cap plate 132. The first sealing member 134 may include an opening that forms a flow path (e.g., gas flow path) connected to the through-hole 137. Through the opening, gas generated during charging and discharging may be discharged from the inside of the case of the secondary battery to the outside, which will be described in detail with reference to FIG. 6. In addition, the specific configuration of the first sealing member 134 will be described in detail with reference to FIGS. 8 to 10.

Additionally, the insulating member 138 may be disposed on a lower surface of the cap plate 132, as described in FIG. 1, and repetitive descriptions thereof will be omitted.

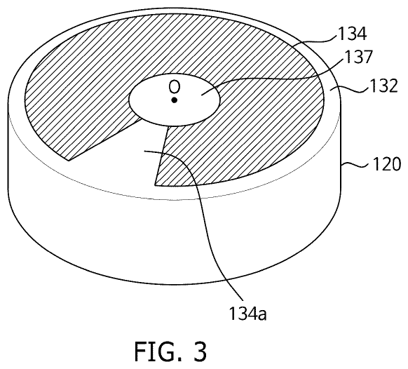

FIG. 3 illustrates a perspective view of an example of the first sealing member 134 according to an embodiment of the present disclosure.

Referring to FIG. 3, a secondary battery may include the case 120 and a cap assembly configured to seal an opening formed at one side of the case 120. An electrode assembly including a first electrode, a separator, and a second electrode may be accommodated within the case 120. The detailed configurations of the cap assembly and the electrode assembly are the same as those previously described with reference to FIGS. 1 and 2, and repetitive descriptions thereof will be omitted.

The first sealing member 134 may be disposed between a terminal plate and the cap plate 132. For example, the first sealing member 134 may be positioned adjacent to the through-hole 137 on the cap plate 132. As shown in FIG. 3, the first sealing member 134 may be formed in a substantially ring shape and may extend to have a predetermined width in a direction from the center O of the cap plate 132 toward an outer circumferential surface of the cap plate 132 (e.g., a predetermined width in a radial direction of the cap plate 132). By forming the first sealing member 134 with a predetermined width extending in this direction, the first sealing member 134 may bond the cap plate 132 and the terminal plate together and seal the space between the cap plate 132 and the terminal plate.

The first sealing member 134 may include an insulating material. For example, the insulating material may include at least one of polypropylene, silicone, epoxy, or urethane. In another example, the insulating material may be any material that functions as an insulator.

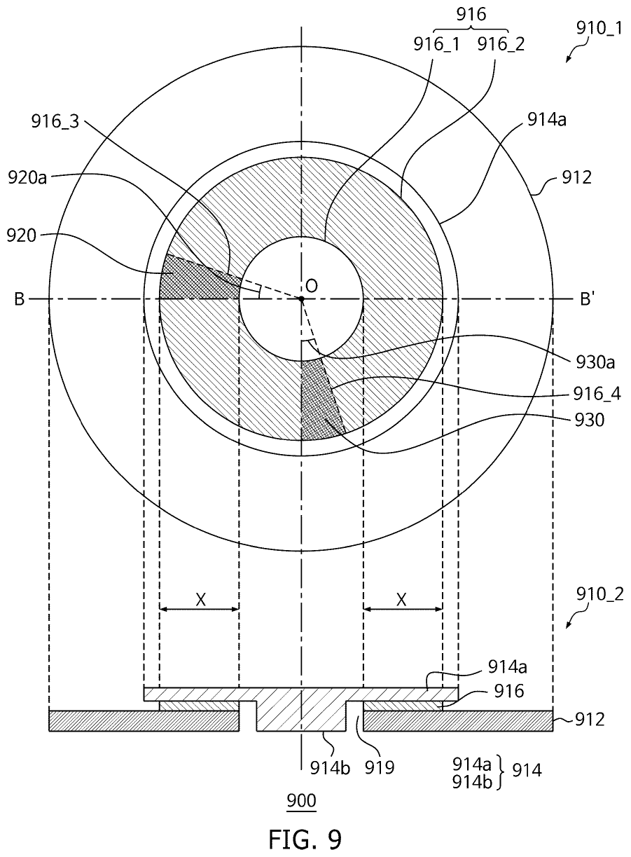

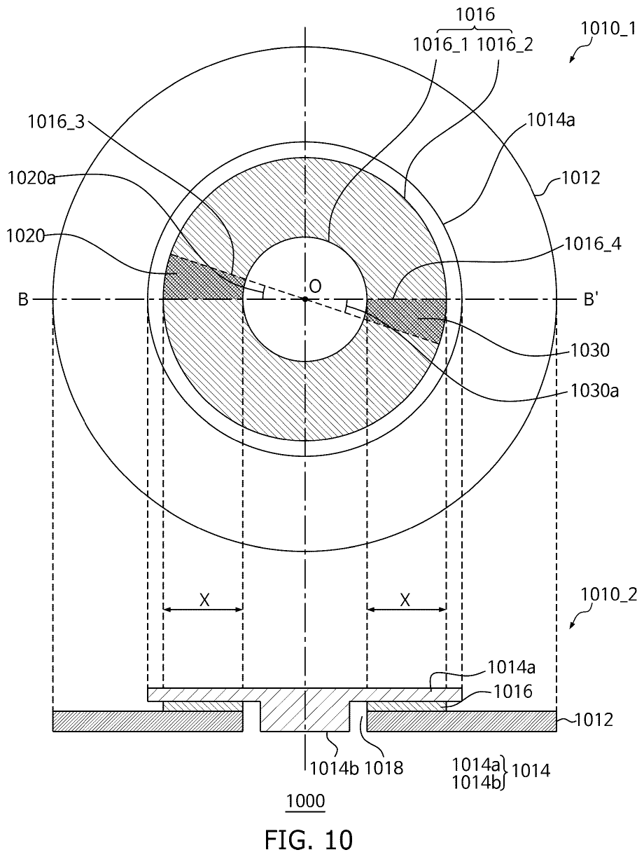

The first sealing member 134 may include an opening 134a that forms a flow path connected to the through-hole 137. The opening 134a may be formed to extend in a direction from the center O of the cap plate 132 toward the outer circumferential surface of the cap plate 132 (e.g., the opening 134a may be a sector of the first sealing member 134 along a radial direction of the first sealing member 134). The opening 134a may be formed by removing at least a portion of the first sealing member 134. For example, the opening 134a may have the form of a discontinuity at one point in the ring-shaped first sealing member 134. In an embodiment, the opening 134a may be formed by cutting a portion of the ring-shaped first sealing member 134 after the ring-shaped first sealing member 134 is manufactured (e.g., so the opening 134a may be in fluid communication with the through-hole 137 and an exterior of the cap assembly). In an embodiment, the first sealing member 134 may include multiple openings 134a, which will be described in detail with reference to FIGS. 9 to 10.

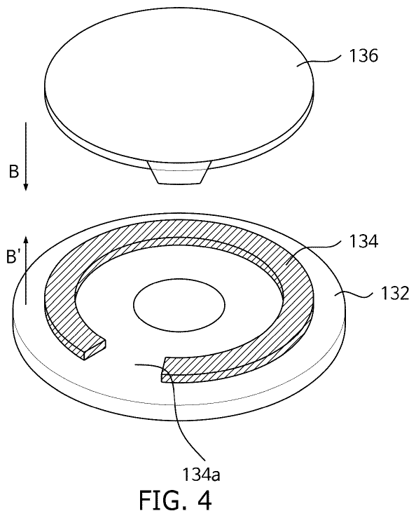

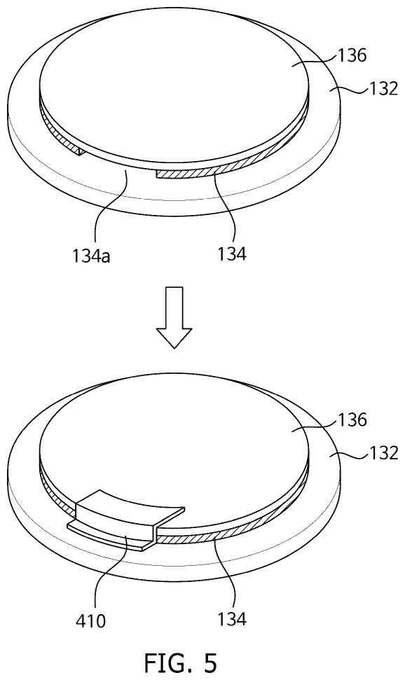

FIG. 4 illustrates a manufacturing process of a cap assembly according to an embodiment of the present disclosure. FIG. 5 illustrates an example of a second sealing member 410 according to an embodiment of the present disclosure. FIG. 6 illustrates an example of a degassing process according to an embodiment of the present disclosure.

Referring to FIG. 4, a cap assembly may be manufactured by separately producing the cap plate 132 and the terminal plate 136, placing a ring-shaped first sealing member 134 between the cap plate 132 and the terminal plate 136, and compressing the cap plate 132 and the terminal plate 136 together with the ring-shaped first sealing member 134 therebetween. For example, the cap assembly is manufactured by placing the ring-shaped first sealing member 134, which has been partially cut away to form the opening 134a, between the cap plate 132 and the terminal plate 136. In an embodiment, the cap assembly may be manufactured by thermally bonding the first sealing member 134 to the cap plate 132 and the terminal plate 136 in directions B and B′ perpendicular to the plane of the cap assembly. As a result, the first sealing member 134 exhibits adhesive properties and couples the cap plate 132 and the terminal plate 136. Additionally, after coupling the cap plate 132 and the terminal plate 136 with the first sealing member 134 therebetween, a second sealing member 410 (FIG. 5), which will be described later, may be attached to the opening 134a of the first sealing member 134.

Referring to FIG. 5, during the formation process of the secondary battery, the cap assembly may further include the second sealing member 410 configured to seal the opening 134a of the first sealing member 134. The second sealing member 410 may be attached to seal the opening 134a of the first sealing member 134.

For example, the second sealing member 410 may be formed to have an area larger than that of the opening 134a of the first sealing member 134 and attached over the opening 134a, e.g., the second sealing member 410 may completely cover the opening 134a. For example, referring to FIG. 5, the second sealing member 410 may be attached simultaneously to at least portions of the first sealing member 134, the terminal plate 136, and the cap plate 132 that surround the opening 134a. In another example, the second sealing member 410 may be attached to one or more components of the cap assembly to ensure the sealing of the opening 134a of the first sealing member 134.

For example, as illustrated in FIG. 5, the second sealing member 410 may have a rectangular shape. In another example, the second sealing member 410 may have any suitable shape as long as the opening 134a can be sealed. The second sealing member 410 may include an insulating material with adhesive properties. For example, the second sealing member 410 may be an adhesive tape including a polyimide material.

Referring to FIG. 6, the second sealing member 410 may be removable from the opening 134a of the first sealing member 134 after the formation process. For example, the formation process may be performed while the second sealing member 410 remains attached. During the formation process, the secondary battery may be activated, and gas may be generated inside the case of the secondary battery. The formation process may include cleaning and charging/discharging processes of the secondary battery.

By removing the second sealing member 410, the gas inside the secondary battery may be discharged through the opening 134a of the first sealing member 134. For example, the opening 134a of the first sealing member 134 may correspond to a flow path through which the gas generated inside the case is discharged to the outside of the case.

According to the above-described configuration, in the manufacturing process of the secondary battery, a gas venting space for discharging an internal gas generated during the formation process may be formed in the cap assembly after inserting the cap assembly into the upper portion of the case and performing welding. Further, a degassing process may be carried out relatively simply by discharging the internal gas through the gas venting space formed in the cap assembly, and then sealing the gas venting space (e.g., the opening 134a) with an insulating member.

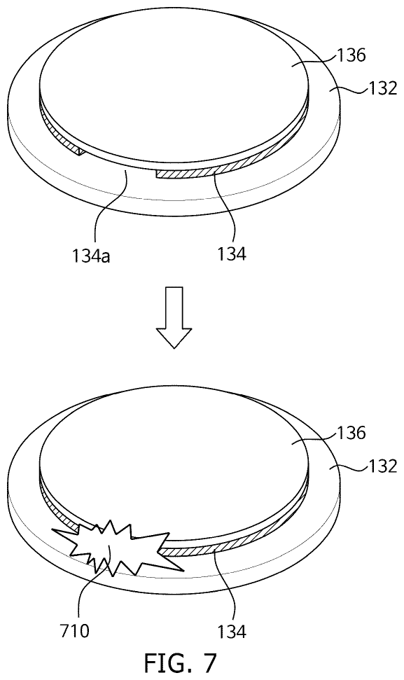

FIG. 7 illustrates an example of a third sealing member 710 according to an embodiment of the present disclosure. Referring to FIG. 7, after the gas generated within the case of the secondary battery is discharged through the opening 134a of the first sealing member 134, a third sealing member 710 may be further provided to seal the opening 134a of the first sealing member 134. For instance, the third sealing member 710 may be disposed at a location where the second sealing member has been removed.

The third sealing member 710 may be an insulating member that is attached to close and seal the opening 134a of the first sealing member 134. For example, the third sealing member 710 may be formed to have an area larger than that of the opening 134a of the first sealing member 134 and may be attached to seal the opening 134a. For example, the third sealing member 710 may be attached simultaneously to at least portions of the first sealing member 134, the terminal plate 136, and the cap plate 132 that surround the opening 134a. In another example, the third sealing member 710 may be attached to one or more components of the cap assembly to seal the opening 134a of the first sealing member 134.

The third sealing member 710 may include an insulating material with adhesive properties. For example, the insulating material may include at least one of a polypropylene adhesive, a silicone adhesive, an epoxy adhesive, or a urethane adhesive.

FIG. 8 illustrates a plan view and a cross-sectional view of an example of a cap assembly 800 according to an embodiment of the present disclosure. A first plan view 810_1 is a top view of the cap assembly 800, while a first cross-sectional view 810_2 is a longitudinal cross-sectional view taken along line B-B′ of the first plan view 810_1.

Referring to the first plan view 810_1 and the first cross-sectional view 810_2, the cap assembly 800 may include a cap plate 812, a terminal plate 814, and a first sealing member 816. The terminal plate 814 may include a protrusion 814b and a flange portion 814a, and the terminal plate 814 may be coupled with the cap plate 812 by inserting the protrusion 814b into a through-hole 818 of the cap plate 812.

In an embodiment, the first sealing member 816 may be formed between the flange portion 814a and the cap plate 812. The first sealing member 816 may be formed in a substantially ring shape and may extend to have a predetermined width in a direction from the center O of the cap plate 812 toward an outer circumferential surface of the cap plate 812.

In an embodiment, the first sealing member 816 may be arranged to surround the protrusion 814b. A diameter of an inner circumference 816_1 of the first sealing member 816 may be greater than a diameter of the protrusion 814b. For example, the diameter of the inner circumference 816_1 of the first sealing member 816 may correspond to (e.g. be equal to) or be greater than a diameter of the through-hole 818.

Further, a diameter of an outer circumference 816_2 of the first sealing member 816 may correspond to (e.g. be equal to) or be smaller than a diameter of the flange portion 814a of the terminal plate 814.

In an embodiment, the size and shape (e.g., the dimension and configuration) of the first sealing member 816 may be appropriately modified in proportion to the size and shape (e.g., the dimension and configuration) of the flange portion 814a of the terminal plate 814. For example, the diameter of the outer circumference 816_2 of the first sealing member 816 may correspond to the diameter of the flange portion 814a of the terminal plate 814. In another example, the diameter of the outer circumference 816_2 of the first sealing member 816 may be smaller than the diameter of the flange portion 814a of the terminal plate 814.

In an embodiment, a length x of the first sealing member 816 in the direction from the center of the cap plate 812 toward the outer circumferential surface of the cap plate 812 may be 2 mm or more. That is, the difference between the diameter of the inner circumference 816_1 of the first sealing member 816 and the diameter of the outer circumference 816_2 of the first sealing member 816 may be 4 mm or more.

An opening 816_3 of the first sealing member 816 may have a shape formed by removing a smaller sector from a larger sector. An angle 820a of the opening 816_3 of the first sealing member 816, which is formed by a first side of the opening 816_3, a second side opposite to the first side, and the center of the cap plate 812, may range from 10 degrees to 15 degrees. A third sealing member 820 may be disposed in the opening 816_3 of the first sealing member 816 to seal the opening 816_3. Accordingly, the third sealing member 820 may also have the angle 820a ranging from 10 degrees to 15 degrees.

FIG. 9 illustrates a plan view and a cross-sectional view of an example of a cap assembly 900 according to an embodiment of the present disclosure. A second plan view 910_1 is a top view of the cap assembly 900, while a second cross-sectional view 910_2 is a longitudinal cross-sectional view taken along line B-B′ of the second plan view 910_1.

Referring to the second plan view 910_1 and the second cross-sectional view 910_2, the cap assembly 900 may include a cap plate 912, a terminal plate 914, and a first sealing member 916. The terminal plate 914 may include a protrusion 914b and a flange portion 914a. By inserting the protrusion 914b into a through-hole 919 of the cap plate 912, the terminal plate 914 may be coupled with the cap plate 912. The structure or the shape of an inner circumference 916_1 and an outer circumference 916_2 of the first sealing member 916 correspond to those described in connection with FIG. 8, and repetitive descriptions thereof will be omitted.

The first sealing member 916 may include a plurality of openings. For example, the plurality of openings of the first sealing member 916 may include a first opening 916_3 and a second opening 916_4. The first opening 916_3 and the second opening 916_4 may be formed so as not to overlap each other on the first sealing member 916. A first closure 920 may be disposed as a third sealing member to seal the first opening 916_3, and a second closure 930 may be disposed as an additional third sealing member to seal the second opening 916_4. For instance, the first closure 920 may have a shape corresponding to the first opening 916_3, and the second closure 930 may have a shape corresponding to the second opening 916_4.

An angle 920a of the first opening 916_3 of the first sealing member 916, which is formed by a first side of the first opening 916_3, a second side opposite to the first side, and the center of the terminal plate 914, may range from 10 degrees to 15 degrees. Similarly, an angle 930a of the second opening 916_4 of the first sealing member 916, which is formed by a third side of the second opening 916_4, a fourth side opposite to the third side, and the center of the terminal plate 914, may also range from 10 degrees to 15 degrees. The first closure 920 and the second closure 930 may be disposed in the first opening 916_3 and the second opening 916_4 to seal the first opening 916_3 and the second opening 916_4, respectively. The first closure 920 and the second closure 930 may be formed to have the same angles as the corresponding openings 916_3 and 916_4 of the first sealing member 916. For example, the angle 920a of the first closure 920 and the angle 930a of the second closure 930 may both range from 10 degrees to 15 degrees.

The second sealing members may be attached to each of the first and second openings 916_3 and 916_4 of the first sealing member 916 to seal the corresponding opening during the formation process. For example, the second sealing member may be formed with an area larger than each of the first and second openings 916_3 and 916_4 of the first sealing member 916 and attached to surround the corresponding opening. In an embodiment, the second sealing member may be attached to each of the first and second openings 916_3 and 916_4 of the first sealing member 916 and contact simultaneously at least portions of the first sealing member 916, the terminal plate 914, and the cap plate 912 that surround the corresponding opening. However, the second sealing member may be attached to one or more components of the cap assembly to seal each of the first and second openings 916_3 and 916_4 of the first sealing member 916.

The second sealing member may be removable from each of the openings of the first sealing member 916 after the formation process. During the formation process, the secondary battery is activated, and gas may be generated inside the case of the secondary battery.

By removing the second sealing member, the gas inside the secondary battery may be discharged through at least one of the first opening 916_3 or the second opening 916_4 of the first sealing member 916. For example, each of the first opening 916_3 and the second opening 916_4 of the first sealing member 916 may correspond to a flow path through which the gas generated inside the case is discharged to the outside of the case. In an embodiment, at least one of the second sealing members attached to the first opening 916_3 and the second opening 916_4 may be removed to discharge (vent) the gas.

FIG. 10 illustrates a plan view and a cross-sectional view of an example of a cap assembly 1000 according to an embodiment of the present disclosure. A third plan view 1010_1 is a top view of the cap assembly 1000, while a third cross-sectional view 1010_2 is a longitudinal cross-sectional view taken along line B-B′ of the third plan view 1010_1.

Referring to the third plan view 1010_1 and the third cross-sectional view 1010_2, the cap assembly 1000 may include a cap plate 1012, a terminal plate 1014, and a first sealing member 1016. The terminal plate 1014 may include a protrusion 1014b and a flange portion 1014a. The terminal plate 1014 may be coupled with the cap plate 1012 by inserting the protrusion 1014b into the through-hole 1018 of the cap plate 1012. The structure or the shape of an inner periphery 1016_1 and an outer periphery 1016_2 of the first sealing member 1016 correspond to those described in connection with FIG. 8, and repetitive descriptions thereof will be omitted.

The first sealing member 1016 may include a plurality of openings. For example, the plurality of openings may include a first opening 1016_3 and a second opening 1016_4. A first closure 1020 may be disposed as a third sealing member to seal the first opening 1016_3, and a second closure 1030 may be disposed as an additional third sealing member to seal the second opening 1016_4. Angles at which the first opening 1016_3 and the second opening 1016_4 are formed, and angles 1020a and 1030a at which the first closure 1020 and the second closure 1030 corresponding to the angles of the first opening 1016_3 and the second opening 1016_4 may range from 10 degrees to 15 degrees.

In an embodiment, the first opening 1016_3 and the second opening 1016_4 may be arranged to be opposite to each other (e.g., symmetrical with respect to each other) about the center axis of the through-hole 1018. The first closure 1020 and the second closure 1030, corresponding to the first opening 1016_3 and the second opening 1016_4, may also be arranged to be opposite to each other about the center axis of the through-hole 1018. Further, the respective second sealing members corresponding to the first opening 1016_3 and the second opening 1016_4 may be attached to be opposite to each other about the center axis of the through-hole 1018.

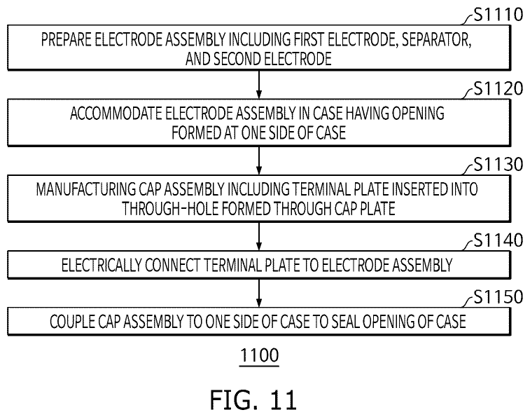

FIG. 11 illustrates a flowchart of a method 1100 for manufacturing a secondary battery according to an embodiment of the present disclosure.

The method 1100 for manufacturing the secondary battery may begin with preparing an electrode assembly including a first electrode, a separator, and a second electrode (S1110).

After S1110 is performed, the electrode assembly may be accommodated in a case having an opening formed at one side thereof (S1120).

Then, a cap assembly including a terminal plate inserted into a through-hole formed through the cap plate may be manufactured (S1130). In S1130, the terminal plate and the cap plate having the through-hole may be fabricated, and a first sealing member having an opening may be disposed between the terminal plate and the cap plate to be positioned adjacent to the through-hole of the cap plate. Subsequently, the first sealing member may be thermally bonded to the cap assembly and the terminal plate. Thereafter, the opening of the first sealing member may be sealed with a second sealing member.

Subsequently, the terminal plate may be electrically connected to the electrode assembly (S1140).

The cap assembly may be then coupled to one side of the case to seal the opening of the case (S1150). In this configuration, the cap assembly includes the first sealing member disposed between the cap plate and the terminal plate to be positioned around the through-hole of the cap plate. The first sealing member may include the opening forming a flow path connected to the through-hole of the cap plate.

Thereafter, a formation process of the secondary battery may be performed, and the second sealing member may be removed from the opening of the first sealing member. Vacuum and pressure may be then applied to discharge gas generated inside the case through the opening of the first sealing member. After the gas generated inside the case has been discharged through the opening of the first sealing member, the opening of the first sealing member may be sealed with a third sealing member.

By way of summation and review, after a cap assembly is inserted into an upper portion of a case and welding is performed, it may be difficult to vent gases generated during cleaning or charging and discharging processes. In contrast, embodiments of the present disclosure provide a cap assembly, a secondary battery including the cap assembly, and a method for manufacturing the secondary battery where the internal gas generated during the formation process in the manufacturing of the secondary battery can be effectively discharged to the outside by utilizing a gas venting opening formed at the sealing member disposed between the cap plate and the terminal plate in the cap assembly, which is disposed to seal the case of the secondary battery.

According to some embodiments of the present disclosure, the formation process can be carried out while an additional sealing member is attached to the gas venting opening formed at the sealing member disposed between the cap plate and the terminal plate in the cap assembly, which is disposed to seal the case of the secondary battery. After the formation process, the additional sealing member is removed, allowing the gas, which is generated inside the secondary battery because of the activation of the secondary battery during the formation process, to be discharged through the gas venting opening of the cap assembly.

According to some embodiments of the present disclosure, after the degassing process is performed through the gas venting opening formed at the sealing member disposed between the cap plate and the terminal plate in the cap assembly that seals the case of the secondary battery, the gas venting opening can be sealed with an additional sealing member, thereby sealing the interior of the case of the secondary battery from the external environment.

However, aspects and features of the present disclosure are not limited to those described above, and other aspects and features not mentioned will be clearly understood by a person skilled in the art from the detailed description, described above.

Although the present disclosure has been described above with respect to embodiments thereof, the present disclosure is not limited thereto. Various modifications and variations can be made thereto by those skilled in the art within the spirit of the present disclosure and the equivalent scope of the appended claims.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A cap assembly, comprising:
a cap plate having a through-hole, the cap plate being couplable to an opening of a case accommodating an electrode assembly of a secondary battery;
a terminal plate inserted into the through-hole of the cap plate, the terminal plate being electrically connectable to the electrode assembly; and
a first sealing member between the cap plate and the terminal plate, the first sealing member being positioned adjacent to the through-hole of the cap plate, and the first sealing member including at least one opening in fluid communication with the through-hole of the cap plate and defining a flow path.

2. The cap assembly as claimed in claim 1, wherein the first sealing member includes an insulating material.

3. The cap assembly as claimed in claim 1, further comprising a second sealing member sealing the at least one opening of the first sealing member during a formation process of the secondary battery, the second sealing member being removable from the at least one opening of the first sealing member after the formation process.

4. The cap assembly as claimed in claim 3, wherein the second sealing member is an adhesive tape including a polyimide material.

5. The cap assembly as claimed in claim 1, wherein the flow path defined by the at least one opening of the first sealing member corresponds to a flow path through which gas generated inside the case is discharged to the outside of the case.

6. The cap assembly as claimed in claim 5, further comprising a third sealing member sealing each of the at least one opening of the first sealing member after the gas is discharged through each of the at least one opening of the first sealing member.

7. The cap assembly as claimed in claim 6, wherein the third sealing member includes an insulating material having adhesive properties.

8. The cap assembly as claimed in claim 7, wherein the insulating material of the third sealing member includes at least one of a polypropylene adhesive, a silicone adhesive, an epoxy adhesive, or a urethane adhesive.

9. The cap assembly as claimed in claim 6, wherein the at least one opening of the first sealing member includes a first opening and a second opening, the third sealing member including a first closure sealing the first opening and a second closure sealing the second opening.

10. The cap assembly as claimed in claim 9, wherein the first opening and the second opening are arranged to be opposite to each other about a center axis of the through-hole.

11. The cap assembly as claimed in claim 1, wherein an angle defined by a first side of the opening of the first sealing member, a second side opposite to the first side, and a center of the terminal plate is in a range from 10 degrees to 15 degrees.

12. The cap assembly as claimed in claim 1, wherein the terminal plate includes:
a flange portion on the cap plate and covering the through-hole; and
a protrusion extending downward from a central region of the flange portion and passing through the through-hole.

13. A secondary battery, comprising:
an electrode assembly including a first electrode, a separator, and a second electrode;
a case electrically connected to the first electrode and accommodating the electrode assembly through a top opening at one side thereof; and
a cap assembly electrically connected to the second electrode and coupled to the top opening of the case to seal the electrode assembly from the outside, the cap assembly including:
a cap plate coupled to the top opening of the case and having a through-hole;
a terminal plate electrically connected to the second electrode and inserted into the through-hole of the cap plate; and
a first sealing member between the cap plate and the terminal plate, the first sealing member being positioned adjacent to the through-hole of the cap plate, and the first sealing member including at least one opening in fluid communication with the through-hole and defining a flow path.

14. The secondary battery as claimed in claim 13, wherein the cap assembly further comprises a second sealing member sealing the at least one opening of the first sealing member during a formation process of the secondary battery, the second sealing member being removable from the at least one opening of the first sealing member after the formation process.

15. The secondary battery as claimed in claim 13, wherein the flow path of the first sealing member corresponds to a flow path through which gas generated inside the case is discharged to the outside of the case.

16. The secondary battery as claimed in claim 15, wherein the cap assembly further comprises a third sealing member sealing the at least one opening of the first sealing member after the gas is discharged through the at least one opening of the first sealing member.

17. A method for manufacturing a secondary battery, the method comprising:
preparing an electrode assembly including a first electrode, a separator, and a second electrode;
accommodating the electrode assembly in a case having a top opening formed through a first side of the case;
manufacturing a cap assembly including a terminal plate inserted into a through-hole formed through a cap plate;
electrically connecting the terminal plate to the electrode assembly; and
coupling the cap assembly to the first side of the case to seal the top opening of the case, the cap assembly including a first sealing member between the cap plate and the terminal plate and adjacent to the through-hole of the cap plate, such that the first sealing member includes at least one opening forming a flow path connected to the through-hole of the cap plate.

18. The method as claimed in claim 17, wherein manufacturing the cap assembly includes:
preparing the terminal plate and the cap plate having the through-hole;
disposing the first sealing member between the terminal plate and the cap plate to be positioned adjacent to the through-hole of the cap plate; and
thermally bonding the first sealing member to the cap plate and the terminal plate.

19. The method as claimed in claim 17, wherein:
manufacturing the cap assembly further comprises sealing the at least one opening of the first sealing member with a second sealing member, and
the method further comprises:
performing a formation process of the secondary battery;
removing the second sealing member from the at least one opening of the first sealing member; and
discharging gas generated inside the case through the at least one opening of the first sealing member by applying vacuum and pressure to the case.

20. The method as claimed in claim 19, further comprising sealing the at least one opening of the first sealing member with a third sealing member after discharging the gas generated inside the case through the at least one opening of the first sealing member.
